(19) United States
(12) Patent Application Publication
(10) Pub. No.: US 2012/0174032 A1
(43) Pub. Date: Jul. 5, 2012

(54) System and Method for Displaying Responses from a Plurality of Users to an Event

(75) Inventors: Todd Greene, San Francisco, CA (US); Stephen Blum, San Francisco, CA (US); Alexey Chalimov, Holon (IL)

(73) Assignee: Trusted Opionion, Inc., San Francisco, CA (US)

(21) Appl. No.: 13/339,520

(22) Filed: Dec. 29, 2011

Related U.S. Application Data
(60) Provisional application No. 61/428,769, filed on Dec. 30, 2010.

(51) Int. Cl. G06F 3/048

(52) U.S. Cl. 715/811

(57) ABSTRACT

The invention relates to a system and method for a computer game and social experience that captures people's emotions at specific moments during a live or pre-recorded event.

This application claims priority to U.S. Provisional Patent Application No. 61/428,769, filed on Dec. 30, 2010, which application is incorporated herein in its entirety.

### FIELD OF THE INVENTION

The invention relates to a system and method for a computer game and social experience that captures people's emotions at specific moments during a live or pre-recorded event and distributes that data to the participants. The captured emotion data may be stored and even combined with the user demographic information.

### BACKGROUND OF THE INVENTION

Surveys are a well-known method to collect data from people. Prior to the widespread use of individual computing systems, a surveyor would conduct surveys in person or over the telephone. Data collected from the surveys could be manually sorted and interpreted or input into electronic files for analysis via various software programs.

There are now numerous companies that allow anyone to prepare and conduct surveys on line, such as SurveyMonkey™ and Zoomerang. These surveys allow for the acquisition of customer feedback using e-mail, social media (e.g., Facebook®), and via web pages that can be visited by survey participants. Generally, the survey respondents do not see the data collected by these companies. Rather, businesses use the collected data to improve their businesses.

There are surveys provided on a variety of websites that do provide participants (or survey respondents) with the current static snapshot of the survey data immediately following the participant's survey input. Similarly, television shows such as “American Idol,” “The X Factor,” and “Dancing with the Stars” provide call-in telephone numbers that correspond to a “vote” for a favorite contestant, which is ultimately aggregated so the results can be announced to the audience. Generally, the telephone voting results are not available in real or even near real time nor do they provide the ability for participants to view data of other participants on an individualized basis.

While on-line surveys have grown in popularity, there has never been a way to gather data regarding the emotions elicited in a viewer of a live or pre-recorded event and provide feedback to all of the participants based on the emotion data elicited. If that ability were made available it could make viewing the event more interesting and could allow friends to interact with respect to an event even if they are watching the event in separate locations.

### BRIEF SUMMARY OF THE INVENTION

In another embodiment, the invention relates to a system for displaying responses from a plurality of users to an event, each of the plurality of users being associated with one a plurality of communication devices, operably connected to a server, each of the communication devices having an associated display, the system comprising a first database operably associated with the server for storing a plurality of user accounts, each user account including unique user identifying information regarding one of the plurality of users; a user interface generator operably associated with the server that causes a plurality of labels to be displayed in association with a plurality of user-actuable buttons on each of the plurality of communication devices associated with the event, wherein each label describes an emotion the plurality of users may express while observing the event; a data aggregator, operably associated with the server, configured to receive user data from each of the plurality of communication devices, wherein the user data pairs the unique user identifying information with the button actuation data of the user and aggregates the button actuation data associated with the event; and a data distributor operably connected to the data aggregator, configured to transmit both the aggregated button actuation data and a subset of the paired user data associated with the event in substantially real time to each of the plurality of communication devices associated with the event, wherein the user interface generator causes a graphical representation of the aggregated button actuation data and the subset of the paired user data associated with the event to be displayed on the display of each of the plurality of communication devices associated with the event.

In another embodiment, the invention further relates to a system, wherein the first database further includes an influential user list, the subset of the paired user data transmitted to each of the plurality of communication devices is determined by the influential user list. Further, each user account on the first database further includes friend list, the subset of the paired user data transmitted to each of the plurality of communication devices is determined by the friend list of the user associated with that communication device. Each user account on the first database further includes an image associated with the user, the data distributor further transmits the image associated with each of the users included in the subset of the paired user data.

In a further embodiment, the invention also relates to a system having a second database operably connected to the server for storing the paired user data in association with the event.

In yet another embodiment, each user account on the first database further includes a friend list, and the subset of the user data transmitted to each of the plurality of communication devices is determined by the friend list of the user associated with that communication device.

In another embodiment, each user account on the first database further includes an image associated with the user, the data distributor further transmits the image associated with each of the users included in the subset of the paired user data.

In one embodiment, the invention relates to a method for displaying responses from a plurality of users to an event, each of the plurality of users being associated with one a plurality of communication devices, operably connected to a server, each of the communication devices having an associated display, the method comprising storing a plurality of user accounts in a first database operably associated with the server, each user account including unique user identifying information regarding one of the plurality of users; causing a user interface associated with the server to be generated, displaying a plurality of labels in association with a plurality of user-actuable buttons on each of the communication devices associated with the event, wherein each label descries an emotion the plurality of users may express while observing the event; receiving user data in a data aggregator from each of the plurality of communication devices, wherein the data aggregator is operably associated with the server and wherein the user data pairs the unique user identifying information with the button actuation data of the user and aggregates the button actuation data associated with the event; and transmitting both the aggregated button actuation data and a subset of the paired user data associated with an event in substantially real time from a data distributor to each of the plurality of communication devices associated with the event, wherein the user interface generator causes a graphical representation of the aggregated button actuation data and the subset of the paired user data associated with the event to be displayed on the display of each of the plurality of communication devices associated with the event.

In another embodiment, the invention relates to a method including a first database further including an influential user list, the subset of the paired user data transmitted to each of the plurality of communication devices is determined by the influential user list.

In still another embodiment, each user account on the first database further includes friend list, the subset of the paired user data transmitted to each of the plurality of communication devices is determined by the friend list of the user associated with that communication device.

In another embodiment, each user account on the first database further includes an image associated with the user, the data distributor further transmits the image associated with each of the users included in the subset of the paired user data.

In yet another embodiment, the method further includes a second database operably connected to the server for storing the paired user data in association with the event.

In another embodiment, each user account on the first database further includes friend list, the subset of the user data transmitted to each of the plurality of communication devices is determined by the friend list of the user associated with that communication device.

In yet another embodiment, each user account on the first database further includes an image associated with the user, the data distributor further transmits the image associated with each of the users included in the subset of the paired user data.

Other systems, methods, features, and advantages of the present invention will be or will become apparent to one with skill in the art upon examination of the following figures and detailed description. All such additional systems, methods, features, and advantages are included within this description, are within the scope of the invention, and are protected by the accompanying claims. Accordingly, the present invention is not restricted except in light of the attached claims and their equivalents.

### BRIEF DESCRIPTION OF THE FIGURES

For a better understanding of the present disclosure, non-limiting and non-exhaustive embodiments are described in reference to the following drawings. In the drawings, like reference numerals refer to like parts through all the various figures unless otherwise specified.

FIGS. 1-4 illustrate one potential embodiment of a user interface associated with one aspect of the invention wherein a user can select an emotion elicited by the show being viewed by pushing a button and view the visual depiction of a range of emotions at the current time.

FIG. 5 illustrates another potential embodiment of a user interface associated with the one aspect of the invention wherein a user can select an emotion elicited by the show being viewed by pushing a button and view a visual depiction of the range of emotions input by all users over time including the current time.

FIG. 6 illustrates a graphical representation of the data stored regarding the overall user experience after a particular event has been completed.

FIG. 7 is a block diagram of the various components associated with an embodiment of the invention.

FIGS. 8 and 9 are block diagrams of two databases, one storing user accounts and information, the second for storing aggregated and sorted data and reports.

### DETAILED DESCRIPTION OF THE INVENTION

In one embodiment, the invention relates to a system for displaying responses from a plurality of users to an event, each of the plurality of users being associated with one a plurality of communication devices, operably connected to a server, each of the communication devices having an associated display, the system comprising a first database operably associated with the server for storing a plurality of user accounts, each user account including unique user identifying information regarding one of the plurality of users; a user interface generator operably associated with the server that causes a plurality of labels to be displayed in association with a plurality of user-actuable buttons on each of the plurality of communication devices associated with the event, wherein each label describes an emotion the plurality of users may express while observing the event; a data aggregator, operably associated with the server, configured to receive user data from each of the plurality of communication devices, wherein the user data pairs the unique user identifying information with the button actuation data of the user and aggregates the button actuation data associated with the event; and a data distributor operably connected to the data aggregator, configured to transmit both the aggregated button actuation data and a subset of the paired user data associated with the event in substantially real time to each of the plurality of communication devices associated with the event, wherein the user interface generator causes a graphical representation of the aggregated button actuation data and the subset of the paired user data associated with the event to be displayed on the display of each of the plurality of communication devices associated with the event.

In another embodiment, the invention further relates to a system, wherein the first database further includes an influential user list, the subset of the paired user data transmitted to each of the plurality of communication devices is determined by the influential user list. Further, each user account on the first database further includes friend list, the subset of the paired user data transmitted to each of the plurality of communication devices is determined by the friend list of the user associated with that communication device. Each user account on the first database further includes an image associated with the user, the data distributor further transmits the image associated with each of the users included in the subset of the paired user data.

In one embodiment, the invention relates to a method for displaying responses from a plurality of users to an event, each of the plurality of users being associated with one a plurality of communication devices, operably connected to a server, each of the communication devices having an associated display, the method comprising storing a plurality of user accounts in a first database operably associated with the server, each user account including unique user identifying information regarding one of the plurality of users; causing a user interface associated with the server to be generated, displaying a plurality of labels in association with a plurality of user-actuable buttons on each of the communication devices associated with the event, wherein each label descries an emotion the plurality of users may express while observing the event; receiving user data in a data aggregator from each of the plurality of communication devices, wherein the data aggregator is operably associated with the server and wherein the user data pairs the unique user identifying information with the button actuation data of the user and aggregates the button actuation data associated with the event; and transmitting both the aggregated button actuation data and a subset of the paired user data associated with an event in substantially real time from a data distributor to each of the plurality of communication devices associated with the event, wherein the user interface generator causes a graphical representation of the aggregated button actuation data and the subset of the paired user data associated with the event to be displayed on the display of each of the plurality of communication devices associated with the event.

The invention relates to a system that is embodied in a computer game/social experience/marketing tool designed to capture users' expression of emotions about specific moments during a live or pre-recorded event where many people are viewing and/or hearing the event simultaneously. The event can be a television show, a movie, a concert, a sporting event, a news event, a dance performance, a radio broadcast, or any other live or pre-recorded experience. The event can be viewed, heard, or otherwise experienced by multiple users, or participants. While it is possible that the multiple users may be experiencing the event together, it is primarily contemplated that the users will be experiencing the event on their television at home physically separate from most, if not all, of the other users. To facilitate this interaction, the system works in conjunction through the user's communication device. Primarily this communication device will be a user's smartphone, such as the iPhone (manufactured by Apple, Inc. of Cupertino, Calif.) or an Android-based phone, via a wireless telephone provider's network. It is also contemplated that the communication device may be a tablet or laptop computer connected to the Internet via WIFI or even a desktop computing device connected to the Internet via a wireless or wired connection.

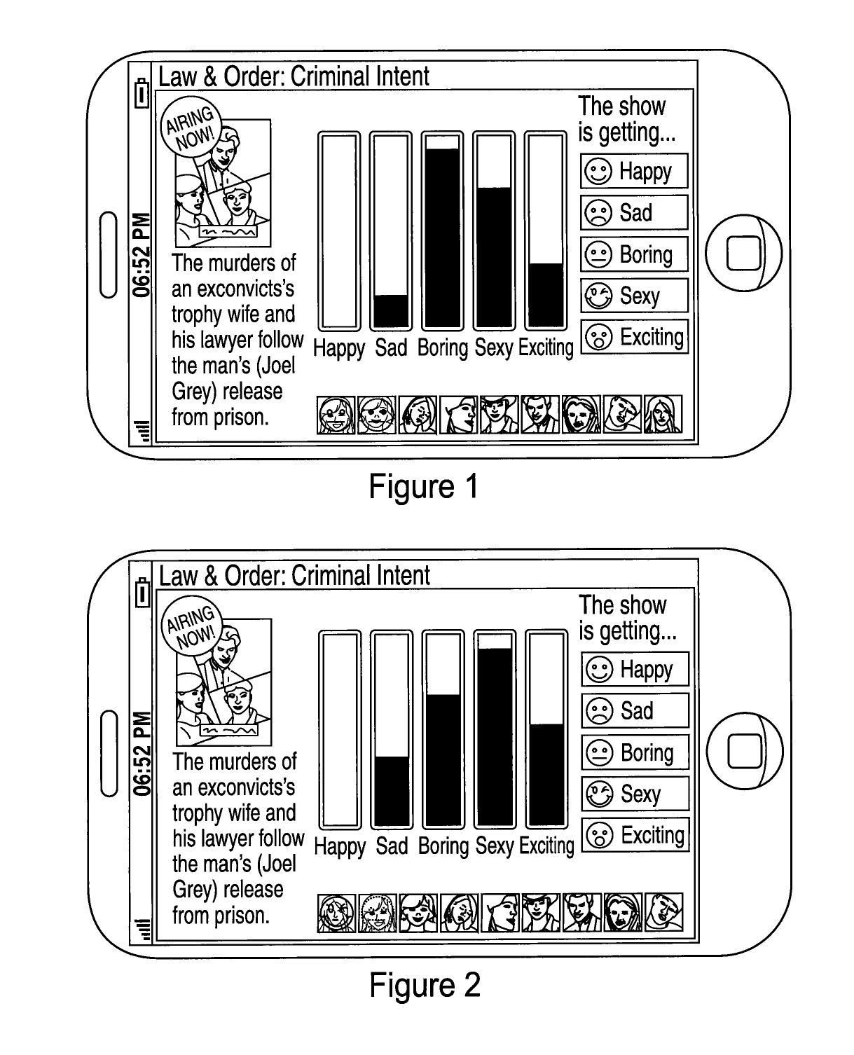

The game can be displayed in various formats. In one embodiment, a user interface is generated and transmitted to the communication devices owned by the plurality of users. As shown in FIGS. 1-5 in an iPhone embodiment, the user interface can include several components. The user interface may display the name of the event being experienced by the user and may include graphics associated with the event. The user may choose the event in a variety of ways. As shown in the figures, the user interface may also include a collection of soft buttons, which when pushed, transmit information. Each of the buttons is labeled with one of a plurality of emotions, such as angry, happy, sad, bored, interested, sexy, excited, horrified, and amazed. In another example, the user interface may generate only three buttons with labels “Agree”, “Disagree”, “Undecided” for use with a political debate. In yet another example, the “emotions” can be the name of an artist performing in a dance or singing competition on television.

As would be understood by those of ordinary skill in the art, the buttons can be any selected to be any format that can be selected or actuated by a user. For instance, it is possible in one embodiment for labels to be displayed adjacent to a mechanical button found on the communication device. The number of buttons and the labels on each are configurable per event. In addition, it is contemplated that the number of buttons and their labels can be changed at one or more points during each event. As shown in the embodiment of FIG. 1, five rectangular-shaped soft buttons may be deployed along the right panel of the smartphone display when the phone is landscape-oriented. As can also be seen in FIGS. 1-5, the buttons may further include a graphic image, which can serve as a shorthand representation of the “emotion.” This shorthand representation may be used to facilitate other functionality that may be supported by the user interface as will be discussed below.

As each user presses a button, that selected emotion is transmitted to a server and collected. The data is aggregated and sorted, and is displayed in substantially real-time.

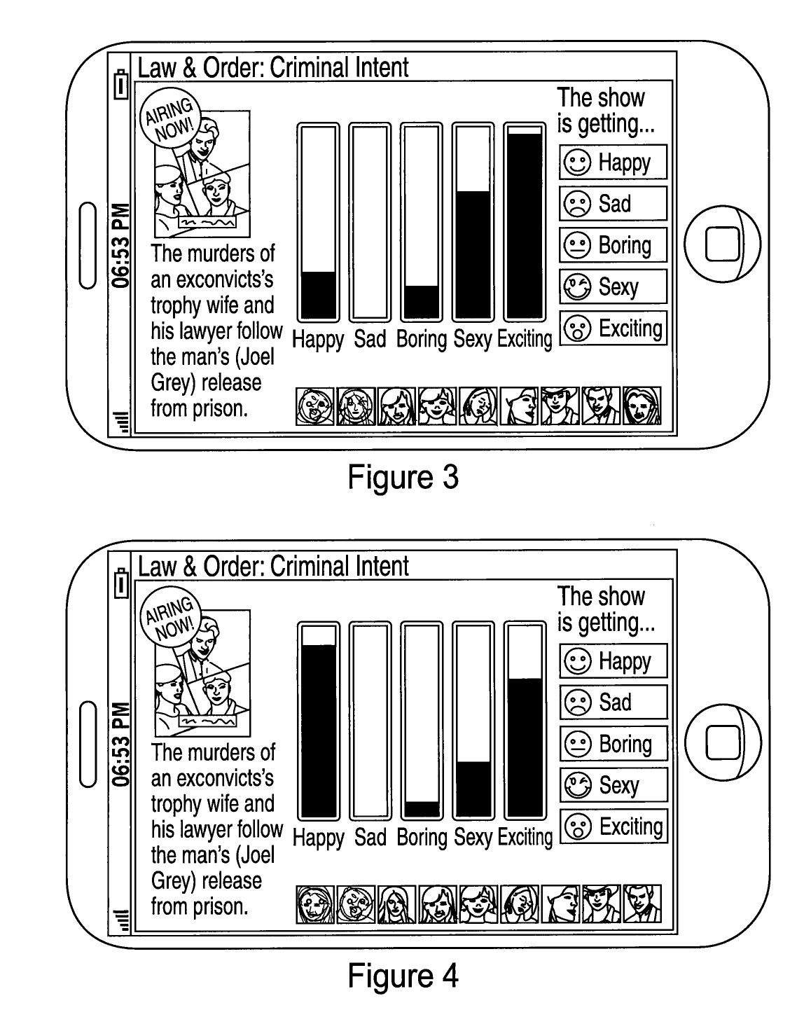

In one embodiment user interface also includes one or more sets of gauges displaying the aggregate selection of emotions by the end-users. The more frequently an emotion button is clicked, the higher the gauge for the corresponding emotion will rise. Over time, the gauge level may fade as fewer people select the button associated with the emotion corresponding to the corresponding gauge. As shown in FIGS. 1-4, the data can be displayed as a bar graph. As shown in FIG. 5, in an embodiment where the data is displayed using a line graph, the changes in data over time can be displayed on the user's communication device.

In one embodiment, the user interface further generates a collection of images that appear, in real-time or near-real-time. These images correspond to a subset of other users who are inputting data in association with the event. As shown in the first and second images at the left of the image array of FIG. 1, in one embodiment of the present invention, the shorthand representation of the “emotion” may be juxtaposed over the image of the user that has just input that data. The users can use the button labels to interpret the emotion icon that has been associated with the image. As would be understood by those of ordinary skill in the art, the emotion data may be displayed in association with the user image data in a variety of ways.

As depicted in FIGS. 1-4, the images may be scrolling from left to right as the button pushes are aggregated and distributed back to the participants. The speed at which the images scroll across the screen can be pre-determined, fixed, or change with time, depending upon how many users are interacting with the system. As more people select emotions, the collection of faces scrolls to show pictures of the most recent user input associated with the event in the system. The faces shown in the user interface can be a random collection of users viewing the same event, selected from a user's “friend” list, and/or selected from a list of “influential” users. The term influential can mean a user that is active in using the system or can mean a user having a certain level of frame (e.g., Nobel laureates, actors, or musicians).

The system may provide algorithmic filtering to prevent all button presses from all users to be broadcast to every other user. The filter priority can be based on, but is not limited to (a) displaying the selected emotions of a user's friends, and (b) highlight specific users who are identified as influential based on their overall use of the system and/or other collected data.

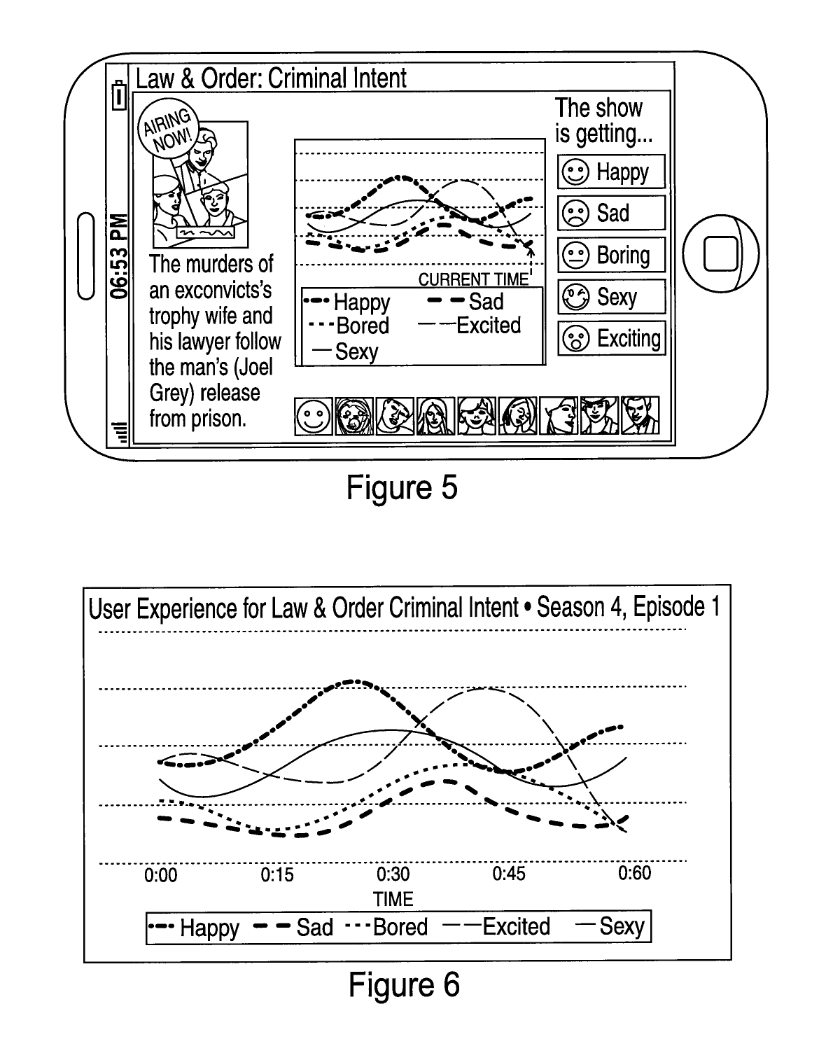

The system will collect all user actuation of the emotion buttons throughout the duration of the event. The emotion data can be analyzed and displayed on a graph to illustrate any emotional peaks or valleys in the event. FIG. 6 shows a graphical display of the results over the course of an entire event. The graph of selected or expresses emotions over time can be displayed to the end-user, and can also be used as data for research and marketing purposes by television and other organizations and businesses. The data generated by the system can also be segmented by geographical regions, as well as other demographic and psychodemographic data to produce information on how an event (such as a television episode) is perceived by different segments of society.

The system can be embedded into many different applications. Some possibilities include, but are not limited to, a mobile “smart-phone” app that is designed to promote a specific event (e.g., a music concert) or a set or series of events (e.g., television episodic content). The system can also be employed in an “Electronic Program Guide” on a tablet or other web browser that allows the users to browse TV programs that are currently airing. Once a currently airing show is selected, the program will be displayed on a user's handheld communications device for the selected show, and the user can interact with the system and input the emotions felt over time.

The system and method can be used with mobile devices, tablet devices, television set-top boxes, and web browsers installed on personal computers. The system and program can be implemented in multiple technologies to fit the device. For example, the program can be implemented in HTML5 and “native” C, Objective C, and Java code.

The steps the program follows will collect user information over time. The program can also optionally synchronize a list of friends from a social network that are watching the same television show or other event.

The system can generate and display a graphical user interface, which including graphical indicators of different user emotions. The indicators can appear as buttons, or as any other means to select a desired emotion to input into the system. The system can receive the user selection of a button press, or actuation, which indicates that the user is feeling a particular emotion at the time the button is pressed. The data received from a user by the system can be combined with the data receive from previous selections of other users. The data is aggregated and sorted, and the combined inputs are pushed back to the users, which provides a shared experience across all users.

The system and method of the invention can also provide for filtering and prioritizing received inputs before those inputs are pushed to the other users. Filtering and prioritization allows the amount sharing to be limited for larger deployments. Alternatively, the data can be filtered or prioritized based on data that has been aggregated and sorted. The filtering of information and data can be performed based on a user's friend list and/or upon an influential user list. The filtered and prioritized data can be displayed on the user interface.

The system generates the results and transmits them to the graphical user interface, where they can be viewed by the users. The results can also be stored in a database. The system can include one database for storing user accounts, user friend lists, influential user lists, user images, raw data, data that has been aggregated and sorted. Alternatively, more than one database can be used to store any combination of the above data and information.

Upon request, the system can generate and present reports and graphs of each data set to demonstrate the selected user emotions of event. The reports can be generated using raw data or based upon the aggregated and sorted data. The data can be segmented by geography, demographics, and psychographics. The reports can be useful in a variety of ways. For example, a television company, a marketing company, or concert promoter could use this data to determine to which demographic a show or other event could be targeted. Additionally, advertising companies could tailor their campaigns based upon the data generated by the system and method of the invention.

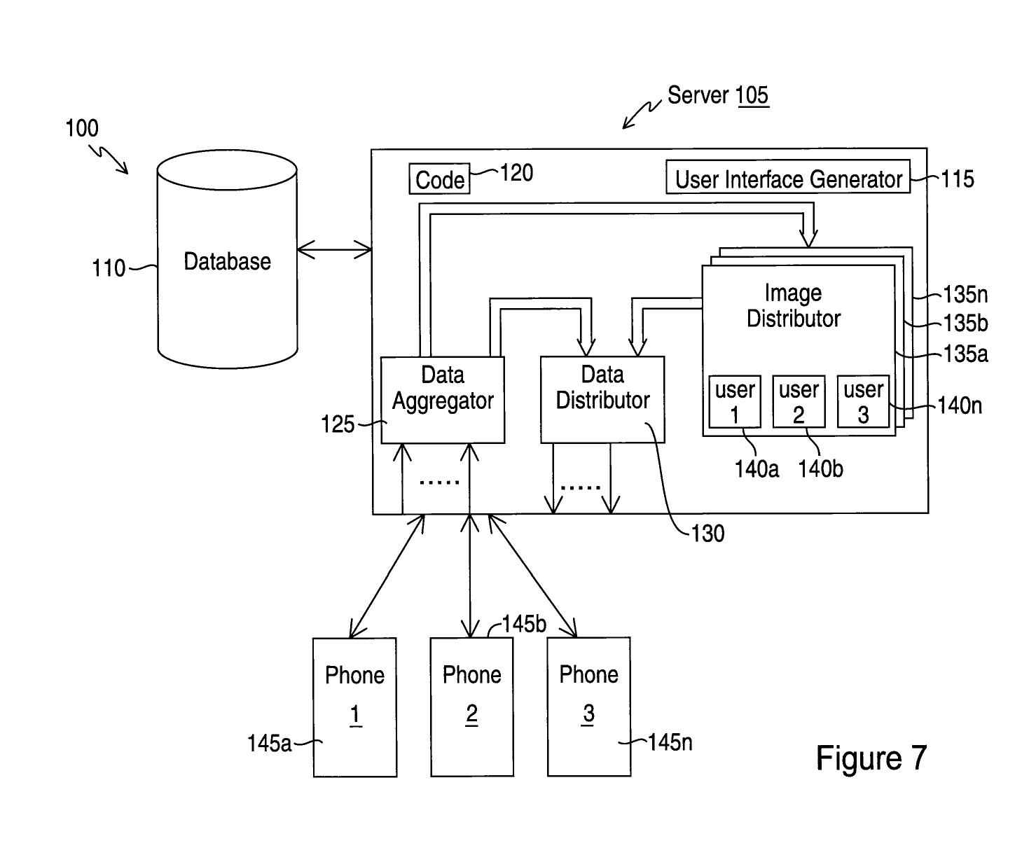

FIG. 7 shows a block diagram of the system of the invention. The system 100 comprises a server 105 that is operably connected to a database 110. The server 105 comprises a user interface generator 115, that uses code 120 to generate buttons that can be pushed to indicate emotions that a user is feeling at the any particular moment. The server 105 further comprises a data aggregator 125 that receives inputs from users pressing the buttons shown in the user interface. The data aggregator 125 is operably connected to both a data distributor 130 and an image distributor(s) 135a, 135b, 135n. The data distributor 130 is operably connected to the image distributor(s) 135a, 135b, 135n, which contains images of all potential users. The image distributor(s) 135a, 135b, 135n can filter the images 140a, 140b, 140n, by a particular user's friend list or by an influential user list, or by both. The system 100 can thereby limit how many user images are distributed and how the images are ranked. The data aggregator 125 receives the input from the users via handheld communication devices 145a, 145b, 145n, and then can aggregate and sort the data. While the server 105 only has one data aggregator 125 and data distributor 130 indicated for one event, the system 100 can comprise numerous data aggregators 125 and data distributers 130, each in use for a different television show or event. The image distributor(s) 135a, 135b, 135n is shown in multiples, because of the number of images that need to be distributed during the course of one or more events.

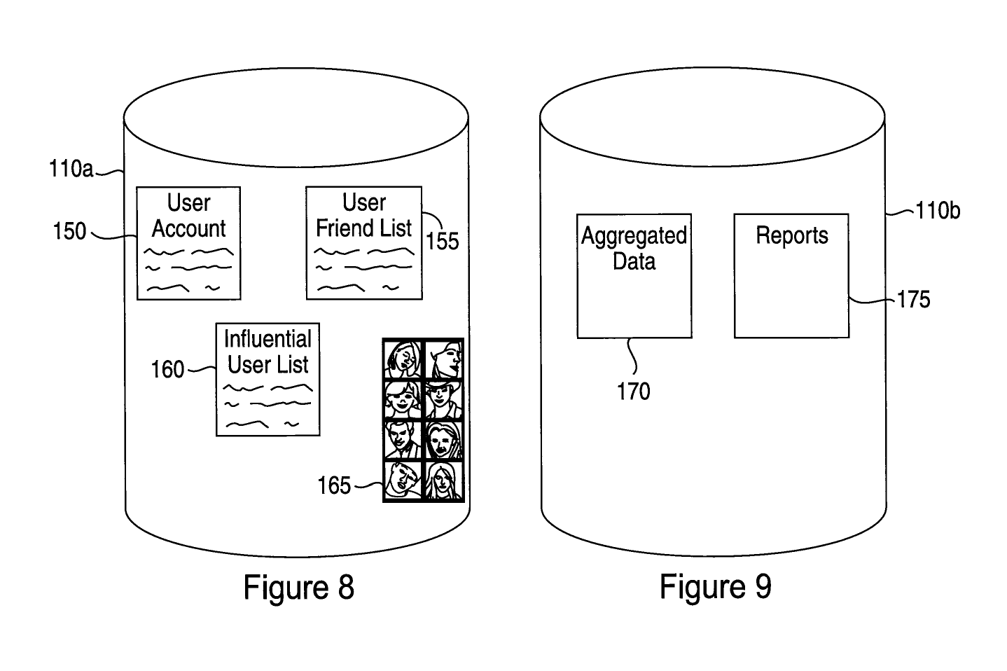

FIGS. 8 and 9 show two databases, which can be substituted for the single database 110 described above. FIG. 8 depicts a first database 110a, which can be used for storing user accounts 150, user friend lists 155, influential user lists 160, and images 165. FIG. 9 depicts a second database 110b, which can be used to store aggregated data and reports generated by the system 100. Alternatively, additional databases can be employed by the system (not shown).

While various embodiments of the present invention have been described above, it should be understood that such disclosures have been presented by way of example only, and are not limiting. Thus, the breadth and scope of the present invention should not be limited by any of the above-described exemplary embodiments, but should be defined only in accordance with the following claims and their equivalents.

Having now fully described the invention, it will be understood by those of ordinary skill in the art that the invention may be performed within a wide and equivalent range of conditions, formulations and other parameters without affecting the scope of the invention or any embodiment thereof. All patents, patent applications, and publications cited herein are fully incorporated by reference in their entirety.

What is claimed is:

1. A system for displaying responses from a plurality of users to an event, each of the plurality of users being associated with one a plurality of communication devices, operably connected to a server, each of the communication devices having an associated display, the system comprising:
a first database operably associated with the server for storing a plurality of user accounts, each user account including unique user identifying information regarding one of the plurality of users;
a user interface generator operably associated with the server that causes a plurality of labels to be displayed in association with a plurality of user-actuable buttons on each of the plurality of communication devices associated with the event, wherein each label describes an emotion the plurality of users may express while observing the event;
a data aggregator, operably associated with the server, configured to receive user data from each of the plurality of communication devices, wherein the user data pairs the unique user identifying information with the button actuation data of the user and aggregates the button actuation data associated with the event; and
a data distributor operably connected to the data aggregator, configured to transmit both the aggregated button actuation data and a subset of the paired user data associated with the event in substantially real time to each of the plurality of communication devices associated with the event,
wherein the user interface generator causes a graphical representation of the aggregated button actuation data and the subset of the paired user data associated with the event to be displayed on the display of each of the plurality of communication devices associated with the event.

2. The system according to claim 1 wherein the first database further includes an influential user list, the subset of the paired user data transmitted to each of the plurality of communication devices is determined by the influential user list.

3. The system according to claim 2 wherein each user account on the first database further includes friend list, the subset of the paired user data transmitted to each of the plurality of communication devices is determined by the friend list of the user associated with that communication device.

4. The system according to claim 3 wherein each user account on the first database further includes an image associated with the user, the data distributor further transmits the image associated with each of the users included in the subset of the paired user data.

5. The system according to claim 4 further including a second database operably connected to the server for storing the paired user data in association with the event.

6. The system according to claim 1 wherein each user account on the first database further includes friend list, the subset of the user data transmitted to each of the plurality of communication devices is determined by the friend list of the user associated with that communication device.

7. The system according to claim 6 wherein each user account on the first database further includes an image associated with the user, the data distributor further transmits the image associated with each of the users included in the subset of the paired user data.

8. A method for displaying responses from a plurality of users to an event, each of the plurality of users being associated with one a plurality of communication devices, operably connected to a server, each of the communication devices having an associated display, the method comprising:
storing a plurality of user accounts in a first database operably associated with the server, each user account including unique user identifying information regarding one of the plurality of users;
causing a user interface associated with the server to be generated, displaying a plurality of labels in association with a plurality of user-actuable buttons on each of the communication devices associated with the event, wherein each label descries an emotion the plurality of users may express while observing the event;
receiving user data in a data aggregator from each of the plurality of communication devices, wherein the data aggregator is operably associated with the server and wherein the user data pairs the unique user identifying information with the button actuation data of the user and aggregates the button actuation data associated with the event; and
transmitting both the aggregated button actuation data and a subset of the paired user data associated with an event in substantially real time from a data distributor to each of the plurality of communication devices associated with the event,
wherein the user interface generator causes a graphical representation of the aggregated button actuation data and the subset of the paired user data associated with the event to be displayed on the display of each of the plurality of communication devices associated with the event.

9. The method according to claim 8 wherein the first database further includes an influential user list, the subset of the paired user data transmitted to each of the plurality of communication devices is determined by the influential user list.

10. The method according to claim 9 wherein each user account on the first database further includes friend list, the subset of the paired user data transmitted to each of the plurality of communication devices is determined by the friend list of the user associated with that communication device.

11. The method according to claim 10 wherein each user account on the first database further includes an image associated with the user, the data distributor further transmits the image associated with each of the users included in the subset of the paired user data.

12. The method according to claim 11 further including a second database operably connected to the server for storing the paired user data in association with the event.

13. The method according to claim 8 wherein each user account on the first database further includes friend list, the subset of the user data transmitted to each of the plurality of communication devices is determined by the friend list of the user associated with that communication device.

14. The method according to claim 13 wherein each user account on the first database further includes an image associated with the user, the data distributor further transmits the image associated with each of the users included in the subset of the paired user data.
